(19) United States
(12) Patent Application Publication
(10) Pub. No.: US 2024/0241831 A1
(43) Pub. Date: Jul. 18, 2024

(54) TECHNIQUES TO REDUCE DATA PROCESSING LATENCY FOR A DEVICE

(71) Applicant: Intel Corporation, Santa Clara, CA (US)

(72) Inventors: Junyuan WANG, Shanghai (CN); Haoxiang SUN, Shanghai (CN); Xin ZENG, Shanghai (CN); Maksim LUKOSHKOV, Clarecastle (IE); Weigang LI, Shanghai (CN); Zijuan FAN, Shanghai (CN); Jun XU, Shanghai (CN)

(21) Appl. No.: 18/622,745

(22) Filed: Mar. 29, 2024

(30) Foreign Application Priority Data
Mar. 19, 2024 (WO) PCT/CN2024/82346

(51) Int. Cl. G06F 12/0862

(52) U.S. Cl. CPC G06F 12/0862; G06F 2212/602

(57) ABSTRACT

Techniques to reduce data processing latency for a device. Circuitry at a device coupled with a host processor can facilitate execution of parallel tasks associated with processing data for a service offloaded to the device from the host processor. The parallel tasks can include prefetching information for address translations related to a shared virtual memory (SVM) space that is shared between the device and the host processor and prefetching data to be processed by device in relation to the offloaded service.

### TECHNICAL FIELD

Examples described herein are generally related to data processing for a device tasked with providing a service offloaded from a host processor.

### BACKGROUND

Data centers based on disaggregated architectures are expected to be the most common types of data centers in the future. Disaggregated architectures, for example, can include offloading of data processing services from a host processor or a host central processing unit (CPU) to a device such as an accelerator device. The data processing services can include, for example, compression/decompression services, crypto (e.g., encryption/decryption) services, or database search services. Service latency can be introduced to offloaded data processing due to data movement between a host processor or CPU and an accelerator device tasked with the offloaded data processing for the service.

### BRIEF DESCRIPTION OF THE DRAWINGS

FIG. 1 illustrates an example first system.

FIG. 2 illustrates an example address translation scheme.

FIG. 3 illustrates example processes for offloaded data processing.

FIG. 4 illustrate an example scatter gather list (SGL) structure.

FIG. 5 illustrates an example work flow.

FIG. 6 illustrates an example process flow.

FIG. 7 illustrates an example logic flow.

FIG. 8 illustrates an example storage medium.

FIG. 9 illustrates an example device.

### DETAILED DESCRIPTION

In some example, data centers based on disaggregated architectures can have service latency introduced when offloading data processing from a host processor or CPU to a device such as an accelerator. Introduction of service latency can be a challenge for some types of services such as, but not limited to, data decompression in which users of these types of service can have a low tolerance for service latency caused when offloading the data processing to the accelerator. An offloading process can introduce extra data processing overhead, for example, due to data movement between the host processor or CPU and the accelerator.

Various technologies have attempted to mitigate or reduce service latency introduced when offloading data processing from a host processor or CPU to a device. One such technology is described in a technical specification published by the Compute Express Link (CXL) Consortium, the technical specification is entitled the CXL Specification, Rev. 3.0, Ver. 1.0, published Aug. 1, 2022, hereinafter referred to as “the CXL specification”. The CXL specification describes ways in which “type 1” and “type 2” devices are allowed to pull or obtain data to be processed from a remote system memory device that can be attached to the host processor or CPU and cache this data to a device local CXL coherent (Coh) cache. Pulling or obtaining the data to be processed to the device local CXL Coh cache can enable type 1 or type 2 devices, which can include accelerator devices, to access the data to be processed more efficiently when in a cache-hit scenario. Another technology to mitigate or reduce service latency is Shared Virtual Memory (SVM). SVM allows a device tasked with offloaded data processing to access a host processor's or CPU's system memory (e.g., remote system memory as compared to the device) with an application's virtual address directly. SVM can reduce data copy in/out between the applications allocated memory space and the device's direct memory access (DMA) memory space. A device arranged to utilize SVM can cache a device address translation table (dTLB) locally to the device to facilitate virtual to physical (V2P) address translations and this caching of entries of the dTLB can reduce V2P translation times significantly for dTLB entry hit scenarios when accessing the host processor's or CPU's system memory.

Two issues can arise when using either a CXL Coh cache or locally caching dTLB entries for SVM. The first issue is that there can be a high cache miss rate in types of offloaded services such as, but not limited to, compression/decompression/cypto services. Data in these types of offloaded services are typically processed in “one-shot” mode that can mean that locally cached data or translations associated with a locally cached dTLB entries have a low chance of being a dTLB entry hit in later data processing. For example, a data decompression service can include needing only one block of compressed data once during an application's execution life cycle. Hence, a V2P addresses translation entry cached to a local dTLB for the one block of compressed data would not be an dTLB entry hit in subsequent data decompression tasks for the data decompression service.

The second issue that can arise when using either CXL Coh cache or locally caching entries to a dTLB for SVM is due to potential data access latency being introduced by a memory page fault in an Address Translation (AT), hereinafter referred to a “page fault”. AT is needed for SVM to enable DMA for a device. AT is also needed for using CXL.cache protocols described in the CXL specification for a CXL Coh cache at a type 1 or type 2 device and the type 1 or type 2 device's ability to pull or obtain data to be processed from a system memory device attached to the host processor or CPU (e.g., remote system memory).

In some examples, to address the first issue related to a one-shot mode, some devices can enlarge a device's CXL Coh cache to help to cache a greater amount of data. However, increasing a memory capacity of a CXL Coh cache enough to avoid most one-shot mode scenarios to acceptably reduce data access latencies can be an unacceptably expensive solution as this increased memory capacity may result in a substantial additional cost. In other examples, another way to address the first issue is to implement prefetching prediction algorithms to attempt to predict what data is to be locally cached to the CXL Coh cache and then prefetch that predicted data to reduce cache miss rates. However, accuracy of these prefetching prediction algorithms for offloaded services can be insufficient to reduce cache miss rates to a level that acceptably reduces data access latencies.

As described in more detail below, logic and/or features of circuitry at a device can be arranged to prefetch data to be processed for a coming data workload from a host processor's or CPU's system memory to cache (e.g., a CXL Coh cache) maintained locally at the device and also prefetch entries for locally cached SVM dTLB entries associated with V2P ATs for the prefetched data. As described in this disclosure, this cache and SVM dTLB entry prefetch process can allow the device to work with data processing related tasks in parallel, and since at least a portion of the data expected to be processed for the offloaded workload is prefetched, a cache-miss rate can be reduced to near 0.

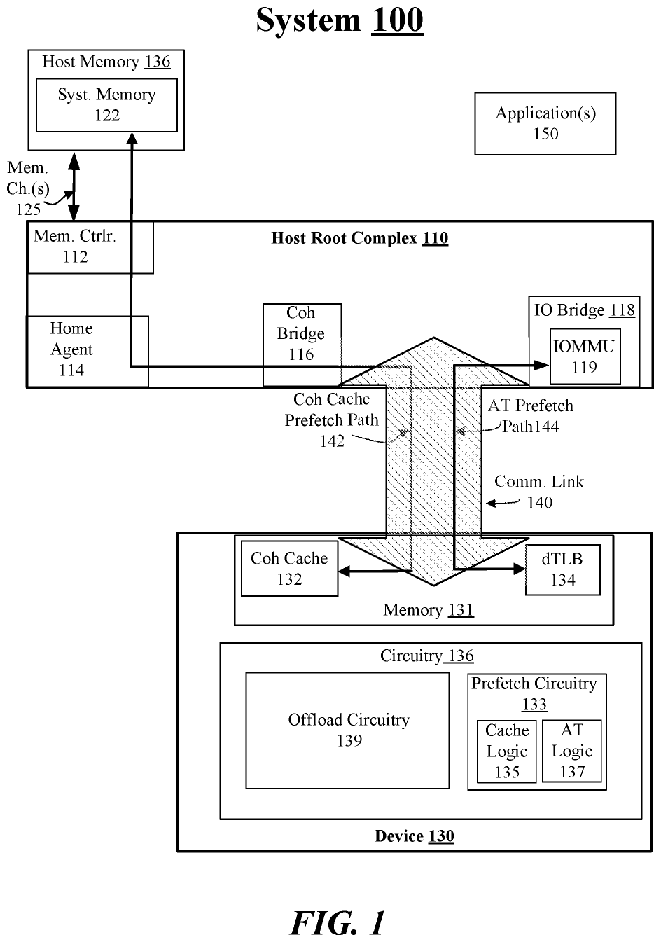

FIG. 1 illustrates an example system 100. In some examples, as shown in FIG. 1, system 100 includes a host root complex 110 coupled with a host memory 120 via one or more memory channel(s) 125 and coupled with a device 130 via a communication link 140. Communication link 140 is depicted in FIG. 1 as a large diagonal patterned arrow. According to some examples, communication link 140 can be configured to operate in accordance with the CXL specification and can be arranged to route communications (e.g., data and/or commands) between hot root complex 110 and device 130 according to communication protocols described in the CXL specification. The communication protocols described in the CXL specification can include, but are not limited to, CXL.mem, CXL.io, or CXL.cache communication protocols. Host root complex 110 can also be configured to operate according to the CXL specification and can be part of and/or integrated with a host processor or CPU (not shown in FIG. 1). Host root complex 110, as shown in FIG. 1, can include a memory controller 112, a home agent 114, a coherency (Coh) bridge 116 and an input/output (IO) bridge 118 that can each be configured to operate according to the CXL specification and/or arranged to use CXL.mem, CXL.io, or CXL.cache communication protocols to communication with elements of device 130 through communication link 140.

In some examples, as shown in FIG. 1, system 100 includes one or more application(s) 150 that are supported by or executed by a host processor or CPU that includes host root complex 110. Application(s) 150 can generate requests that cause processing of a workload offloaded from the host processor or CPU to device 130. Also, as shown in FIG. 1, device 130 includes circuitry 136. Circuitry 136 can be configured to include a prefetch circuitry 133 and an offload circuitry 139. As described in more detail below, prefetch circuitry 133 can include logic and/or features such as a cache logic 135 to facilitate prefetching of data to be processed by offload circuitry 139 for the offloaded workload based on a request received from an application included in application(s) 150 to process the data. For these examples, cache logic 135 can be arranged to prefetch the data from a remote system memory 122 maintained at host memory 120 of a host processor or CPU integrated with or including host root complex 110 to a local Coh cache 132 maintained in memory 131 at device 130. For these examples, the data can be prefetched from system memory 122 via a Coh cache prefetch path 142. As shown in FIG. 1, Coh cache prefetch path 142 can be routed between the remote system memory 122 at host memory 120 to Coh cache 132 at device 130. At least a portion of Coh cache prefetch path 142 can be routed over memory channel(s) 125 to memory controller 112, then routed between elements of host root complex 110 that includes home agent 114 and Coh bridge 116, Coh Cache prefetch path 142 can then be routed between Coh bridge 116 and Coh cache 132 at device 130 over communication link 140.

According to some examples, also described in more detail below, logic and/or features of prefetch circuitry 133 such as address translation (AT) logic 137 can facilitate prefetching of dTLB entries that are locally cached and associated with shared virtual memory (SVM) between device 130 and application(s) 150. For these examples, the dTLB entries can be prefetched to a device translation table (dTLB) 134 maintained in memory 131 at device 130. The dTLB entries, for example, can be prefetched from an input/output memory management unit (IOMMU) 119 of IO bridge 118 at host root complex 110 via an AT prefetch path 144 routed over communication link 140. The prefetched dTLB entries, for example, can be associated with a virtual-to-physical (V2P) address translations for data that is to be prefetched from system memory 122 and placed in Coh cache 132 as mentioned above.

In some examples, circuitry 136 can include processor circuitry (e.g., CPU or graphics processing unit), one or more field programmable gate arrays (FPGAs), one or more application specific integrated chips (ASICs) or a combination of processor circuitry, FPGAs or ASICs. For example, offload circuitry 139 included in circuitry 136 can be processor circuitry and prefetch circuitry 133 can be an FPGA or an ASIC. In other examples, circuitry 136 can be a single processor circuitry, FPGA or ASIC and offload circuitry 139 and prefetch circuitry 133 can be separate portions of this single processor circuitry, FPGA or ASIC.

According to some examples, memory included in host memory 120 and/or memory 131 can include any combination of volatile or non-volatile memory. For these examples, the volatile and/or non-volatile memory included in host memory 120 and/or memory 131 can be arranged to operate in compliance with one or more of a number of memory technologies described in various standards or specifications, such as DDR3 (double data rate version 3), JESD79-3F, originally released by JEDEC in July 2012, DDR4 (DDR version 4), JESD79-4C, originally published in January 2020, DDR5 (DDR version 5), JESD79-5B, originally published in September 2022, LPDDR3 (Low Power DDR version 3), JESD209-3C, originally published in August 2015, LPDDR4 (LPDDR version 4), JESD209-4D, originally published by in June 2021, LPDDR5 (LPDDR version 5), JESD209-5B, originally published in June 2021, WIO2 (Wide Input/output version 2), JESD229-2, originally published in August 2014, HBM (High Bandwidth Memory), JESD235B, originally published in December 2018, HBM2 (HBM version 2), JESD235D, originally published in January 2020, or HBM3 (HBM version 3), JESD238A, originally published in January 2023, or other memory technologies or combinations of memory technologies, as well as technologies based on derivatives or extensions of such above-mentioned specifications. The JEDEC standards or specifications are available at www.jedec.org.

Volatile types of memory may include, but are not limited to, random-access memory (RAM), Dynamic RAM (DRAM), DDR synchronous dynamic RAM (DDR SDRAM), GDDR, HBM, static random-access memory (SRAM), thyristor RAM (T-RAM) or zero-capacitor RAM (Z-RAM). Non-volatile types of memory may include byte or block addressable types of non-volatile memory having a 3-dimensional (3-D) cross-point memory structure that includes, but is not limited to, chalcogenide phase change material (e.g., chalcogenide glass) hereinafter referred to as “3-D cross-point memory”. Non-volatile types of memory may also include other types of byte or block addressable non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

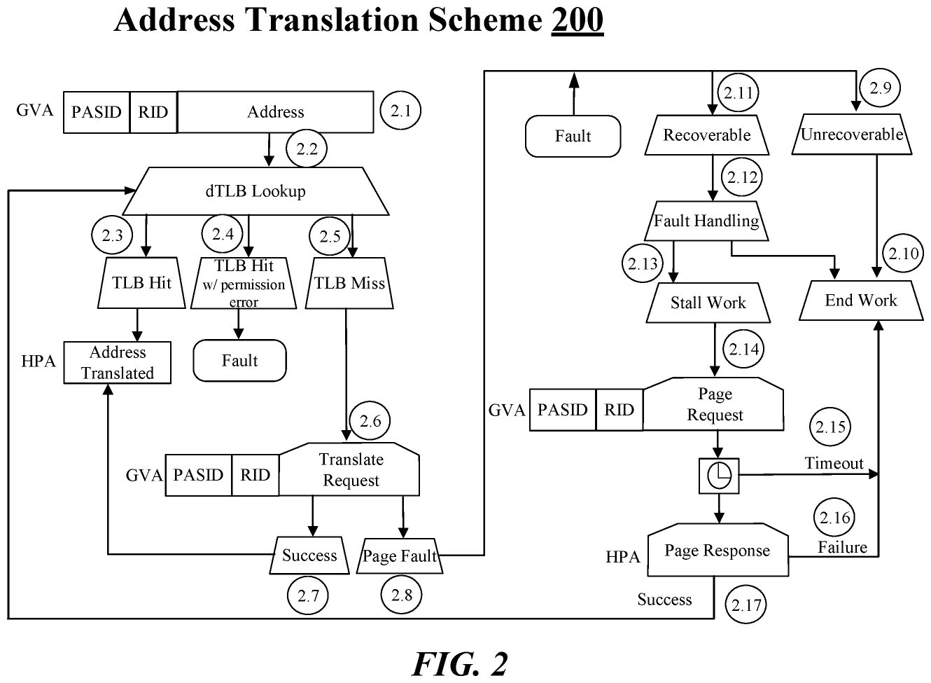

FIG. 2 illustrates an example address translation scheme 200. In some examples, elements of system 100 such as elements of host root complex 110, host memory 120, device 130, or application(s) 150 can be arranged to implement at least a portion of address translation scheme 200 that can be associated with SVM. Address translation scheme 200 can be related to how dTLB entries maintained in a dTLB (e.g., dTLB 134) can be used to perform an V2P address translation associated with memory addresses maintained in system memory 122 in order for logic and/or features of prefetch circuitry 133 to prefetch data from system memory 122 into Coh cache 132 to enable offload circuitry 139 to process data for a workload offloaded to device 130. Examples are not limited to elements of system 100 for implementing address translation scheme 200.

According to some examples, at 2.1, a request that includes a process address space identifier (PASID), a resource identifier (RID) and an address. For these examples, the request can be a direct memory access (DMA) request from an application from among application(s) 150 and the address included in the request is a guest virtual address (GVA). The GVA, for example, can be included in an SVM space assigned to the application to maintain data to be processed for the workload offloaded to device 130.

In some examples, at 2.2, logic and/or features of prefetch circuitry 133 at device 130 (e.g., AT logic 137) can be arranged to perform a dTLB lookup to see if a dTLB entry in dTLB 134 corresponds to a GVA translation to a host physical address (HPA) for the GVA included in the request. In other words, logic and/or features of prefetch circuitry 133 determines whether dTLB 134 has a V2P translation entry to translate the GVA to a HPA. The HPA, for example, can be used to access the data to be processed by offload circuitry 139 from either system memory 122 (if the data has not been prefetched) or from Coh cache 132 (if the data was prefetched).

According to some examples, at 2.3, if dTLB 134 includes a V2P translation entry to translate the GVA indicated in the request to an HPA, this is a TLB hit. Also, if the application placing the request has permission to access this HPA, that V2P translation entry is used by logic and/or features of prefetch circuitry 133 to translate the GVA.

In some examples, at 2.4, even if dTLB 134 includes a V2P translation entry to translate the GVA indicated in the request to an HPA, the application placing the request does not have permission to access or lacks adequate credentials to access the translated HPA. For these examples, a fault is indicated. This fault, for example, can cause the application to seek the proper permission before attempting to access the data again.

According to some examples, at 2.5, dTLB 134 does not include a V2P translation entry to translate the GVA indicated in the request to an HPA.

In some examples, at 2.6, a lack of the V2P translation entry in dTLB 134 can cause logic and/or features of prefetch circuitry 133 to cause a translation request to be sent to IOMMU 119 to obtain the V2P translation entry for the GVA indicated in the request to the HPA.

According to some examples, at 2.7, based on a successful translation request, IOMMU 119 can provide the V2P translation entry if the application that generated the request has permission (e.g., has been assigned to that address space) and/or a memory page/page table maintained by IOMMU 119 includes the V2P translation entry.

In some examples, at 2.8, a page fault indicates that IOMMU 119 could not provide the V2P translation entry and that page fault handling actions need to be taken.

In some examples, at 2.9, IOMMU 119 can determine that the page fault is unrecoverable. For example, the application that placed the request does not have permission to access the translated HPA or no actual address exists for the translated HPA.

According to some examples, at 2.10, IOMMU 119 can indicate that the page fault is unrecoverable and this leads to an end work on the workload offloaded to device 130. For these examples, additional requests with the same PASID, can be blocked from further translation and logic and/or features of prefetch circuitry 133 can cause a fault response to be sent to the application to indicate that an unrecoverable page fault has occurred.

In some examples, at 2.11, IOMMU 119 can indicate that the page fault is recoverable.

According to some examples, at 2.12, logic and/or features of prefetch circuitry 133 can implement fault handling. The fault handling can include an end work action as mentioned above for 2.10 or the fault handling can include a stall work action as described below.

In some examples, at 2.13, fault handling that includes a stall work action can include at least temporarily halting execution or data processing by offload circuitry 139 for the workload offloaded to device 130. The halt, for example, can result in the application causing an update to page tables maintained by IOMMU 119 to include V2P translation for the GVA included in the request.

According to some examples, at 2.14, logic and/or features of prefetch circuitry 133 will send a second request to IOMMU 119 for the V2P translation for the GVA included in the request following a period of time for the stall work action to enable the application to cause an update to the page tables maintained by IOMMU 119.

In some examples, at 2.15, if a response to the second request is not received after a second period of time, then a timeout is determined and an end work action is implemented as mentioned above for 2.10.

According to some examples, at 2.16, if a response is received within the second period of time, but the response is not a memory page via which the application and/or device 130 has access to, then this is considered a failure by logic and/or features of prefetch circuitry 133 and an end work action is implemented as mentioned above for 2.10.

In some examples, at 2.17, if a response is received within the second period of time and the application and device 130 have access to the translated address, logic and/or features of prefetch circuitry 133 add the V2P translation entry to dTLB 134 at device 130. For these examples, the GVA included in the request can then be translated to an HPA in order to access the data from either system memory 122 (if the data has not been prefetched) or from Coh cache 132 (if the data was prefetched). Address translation scheme 200 can then be complete as related to the received request.

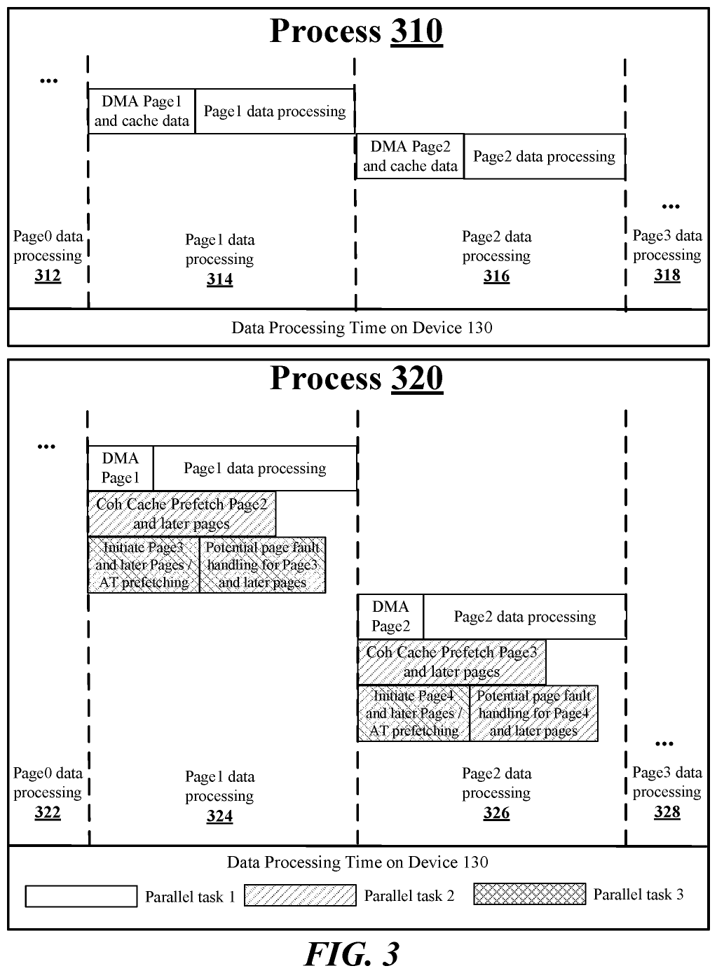

FIG. 3 illustrates example processes 310 and 320 for offloaded data processing. In some examples, processes 310 or 320 can be implemented by elements of system 100 shown in FIG. 1. For example, elements of host root complex 110, host memory 120, device 130, or application(s) 150 can be arranged to implement at least portion of processes 310 or 320. Examples are not limited to these elements of system 100 for implementing processes 310 or 320 for offloaded data processing.

According to some examples, process 310 can represent offloaded data processing that does not include execution of parallel tasks. For these examples, logic and/or features of prefetch circuitry 133 do not preform prefetch actions to either prefetch data from system memory 122 or prefetch dTLB entries from IOMMU 119. Rather, as shown in FIG. 3, process 310 indicates that actions occur in a sequential/pipeline order, without prefetching. For example, following Page0 data processing 312 at device 130, Page1 data processing 314 includes logic and/or features of prefetch circuitry 133 first performing a DMA of data associated with Page1 from system memory 122 and cause that data to be cached locally at device 130 (e.g., to Coh cache 132). Following the local caching of the Page1 data and V2P translations, the Page1 data is processed by offload circuitry 139. Then, Page2 data processing 316 includes performing a DMA of data associated with Page2 from system memory 122 and cause that Page2 data to be cached locally at device 130. Page3 data processing 318 can include a similar sequence of actions and subsequent pages of data can be obtained until data for an offloaded workload to device 130 is completed. The sequential/pipelined actions and lack of prefetching data from system memory 122 or prefetching dTLB entries can result in data processing latencies for the reasons mentioned previously as related to waiting for the data to be pulled from system memory 122 and related to waiting for V2P translation entries from IOMMU 119 if a V2P translation entry is missing for any of Page0 to Page3. Also, if a page fault occurs for any of Page0 to Page3 for V2P translation requests during process 310, additional data processing latencies can be introduced to the data processing time on device 130, provided the page fault is recoverable.

In some examples, process 320 can represent a process that includes performing 3 parallel tasks. As shown in FIG. 3, parallel task 1 is included in non-patterned boxes, parallel task 2 is included in angled-line patterned boxes, and parallel task 3 is included in cross-hatched patterned boxes. For these examples, parallel task 1 can be similar to the sequential actions mentioned above for process 310. However, process 320 also shows 2 additional parallel tasks being implemented while parallel task 1 is being implemented. For example, Page1 data processing 324 can include Coh cache prefetch of Page2 and later pages, initiate Page3 and later pages/AT prefetching, and potential page fault handling for Page3 and later pages. The indication of “later pages” can indicate that page data or V2P address translation (dTLB) entries for more than 1 memory page can be prefetched, but at least 1 page of data and associated V2P address translation entry(s) need to be prefetched to allow for parallel execution of tasks during processing of a memory page of data at device 130. Although not shown in FIG. 3, Page0 data processing 322 can include the prefetching of Page1 and the initiation of Page2 and later pages/AT prefetching due to the need for an address translation (AT) of Page2 memory addresses in order to prefetch Page2 data from system memory 122 at Page1 data processing 324. Because prefetching of Page3 data occurs at Page2 data processing 326 of process 320, the initiation of Page3 and later pages/AT prefetching at Page1 data processing 324 along with preemptive page fault handling ensures that a V2P address translation entry for at least Page3 has been prefetched to dTLB 134 maintained at device 130 in order prefetch Page3 data from system memory 122 at Page2 data processing 326. Although not shown in FIG. 3, a similar mix of parallel tasks can be implemented during Page3 data processing 328.

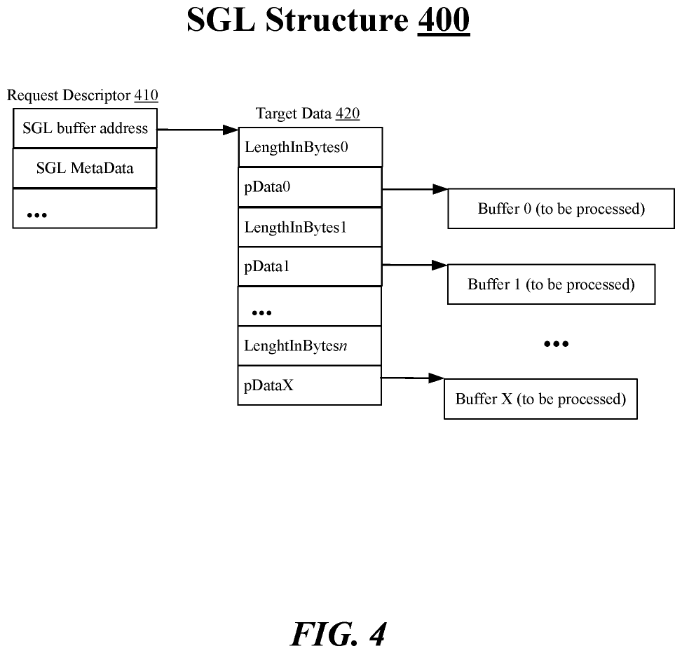

FIG. 4 illustrates an example scatter gather list (SGL) structure 400. In some examples, SGL structure 400 provides an example of a type of data input structure for a service offloaded to a device such as device 130. For these examples, the offloaded service can include, but are not limited to, a data compression service and a type of application such as a database application can issue a service processing request descriptor in the example format of request descriptor 410 that includes an SGL buffer address and SGL MetaData. The SGL buffer address can be virtual memory addresses included in an SVM space shared between device 130 and a host processor or host CPU that includes a host root complex that couples with a host memory of the host processor or host CPU. Device 130 can parse the information included in request descriptor 410 to determine target data 420. As shown in FIG. 4, target data 420 is not for a single buffer but is for multiple buffers that can be organized as a type of scatter gather buffer list structure that indicates a length in bytes for each of Page0 to PageX data (pData0 . . . pDataX) that is to be placed in buffers 0 to X for offloaded data processing at the device in association with the offloaded compression service. Following a process that includes multiple parallel tasks such as process 320, device 130 can obtain one buffer's data and process that data while pre-fetching next buffer's V2P address translation entries to a locally maintained dTLB table (e.g., dTLB 134) and using the V2P address translations entries for pre-fetching next buffer's data from physical memory addresses at host memory to a locally maintained cache (e.g., Coh cache 132).

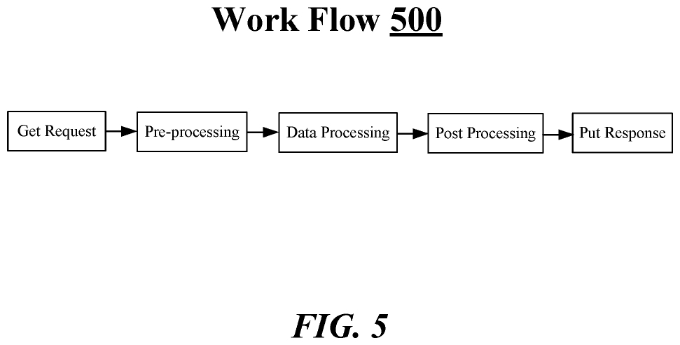

FIG. 5 illustrates example work flow 500. In some examples, work flow 500 can be an example work flow for an offloaded service to a device such as device 130. For these examples, as shown in FIG. 5, work flow 500 includes a get request portion, a pre-processing portion, a data processing portion, a post processing portion and a put response portion that represent a generic working flow for the offloaded service. As described in more detail below, for an example process flow, the work flow portions shown in FIG. 5 can be implemented to decouple SVM dTLB and Coh cache pre-cache or prefetching tasks from a legacy data processing pipeline sequence similar to what was described above for process 310 and take a greedy manner in data fetching via parallel tasks that look ahead for SVM dTLB entries and addressing possible page faults to pull/prepare as much data as possible from a system memory for the data processing portion of work flow 500.

In some examples, where the Coh cache is arranged to operate according to the CXL specification, in order to improve performance of the offloaded service by device 130, data prefetched to Coh cache 132 can be cached with Write-Only (WO) access permission and take a write-backs policy when writing data back to a host processor's or host CPU's system memory (e.g., system memory 122). This can be done by either an implicit host data snoop process or an explicit device cache capacity eviction process. Either of these two processes, for example, can utilize CXL.cache or CXL.mem communication protocols.

Included herein is a set of logic or process flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic or process flow may be implemented in software, firmware, and/or hardware. In software and firmware embodiments, a logic or process flow may be implemented by computer executable instructions stored on at least one non-transitory computer readable medium or machine readable medium, such as an optical, magnetic or semiconductor storage. The embodiments are not limited in this context.

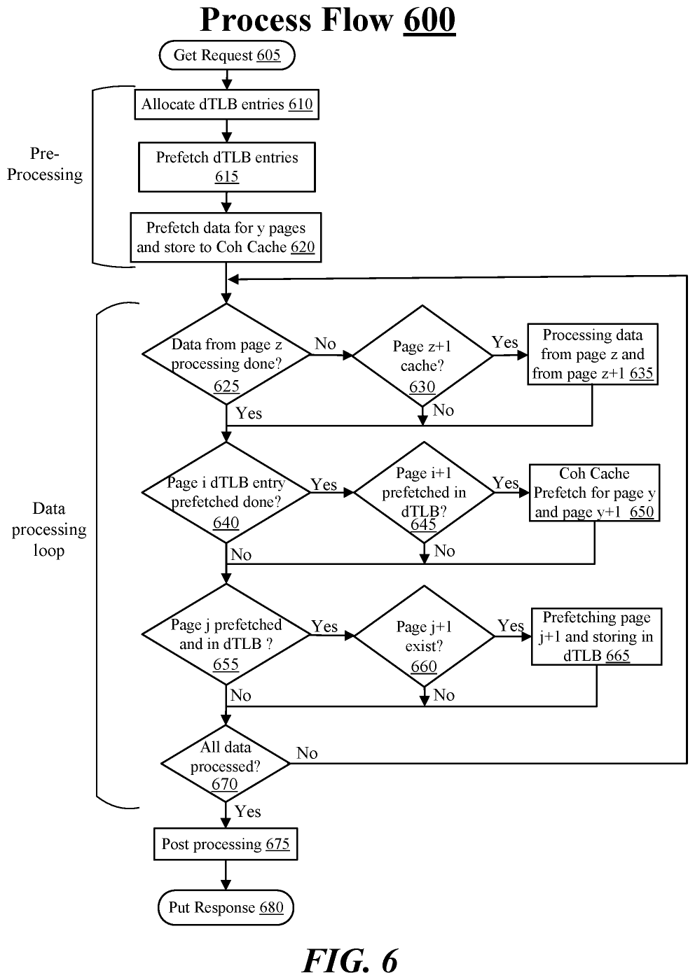

FIG. 6 illustrates an example process flow 600. According to some examples, process flow 600 shows a more detailed example of an implementation of the various portions of work flow 500. For these examples, process flow 600 depicts an example of how to decouple SVM dTLB and Coh cache pre-cache or prefetching tasks from a legacy data processing pipeline sequence that includes multiple actions to be taken during pre-processing and during a data processing loop to enable parallel tasks to be performed in order to reduce data processing latencies. Elements of system 100 as shown in FIG. 1 such as host root complex 110, host memory 120, device 130 and application(s) 150 can be configured to implement at least portions of process flow 600. Although examples are not limited to elements of system 100 or to sub-elements of the above-mentioned elements of system 100.

Beginning at 605, circuitry 136 of device 130 get a request from an application from among application(s) 150 to process data associated with an offloaded service. According to some examples, the request can be in an example format of SGL structure 400 that includes a request descriptor 410 that indicates an SGL buffer address and SGL MetaData to indicate virtual memory addresses for data (e.g., page data) that is included in an SVM space that is shared between device 130 and the host processor or host CPU that includes host root complex 110 in order obtain the data from system memory 122 to fulfill the request.

Moving to block 610, the request can indicate that multiple pages or “x” number of pages are to be obtained from system memory 122. The memory addresses indicated in the request can be GVAs (virtual memory addresses) for the x number of pages that will need to be translated to HPAs (physical memory addresses) in order to prefetch the data to be processed. According to some examples, dTLB entries for these V2P address translations for the x number of pages can be allocated to dTLB 134 by logic and/or features of prefetch circuitry 133 such as AT logic 137.

Moving to 615, AT logic 137 can prefetch or obtain dTLB entries for the V2P address translations for at least a portion of the x number of pages that correspond to the SGL buffer addresses for buffers of the at least first several pages of the x number of pages. In some examples, AT logic 137 can prefetch the dTLB entries for the x number of pages from IOMMU 119 at host root complex 110 via AT prefetch path 144 routed over communication link 140.

Moving to 620, logic and/or features of prefetch circuitry 133 such as cache logic 135 can use the prefetched dTLB entries to prefetch or obtain page data from system memory 122 for at least a portion of the x number of pages. The at least a portion of the x number of pages could be y number of pages due to allowing for the prefetching of y pages of data before receiving all address translations for the x number of pages. The y pages of data, for example, can be prefetched to Coh cache 132 at device 130. According to some examples, cache logic 135 can prefetch at least y pages of data from system memory 122 via Coh cache prefetch path 142 routed over communication link 140.

Moving to decision 625 where a data processing loop begins. According to some examples, the data processing loop is entered when a first page of the x pages, shown as “page z”, has been pulled from Coh cache 132 by cache logic 135 and provided to offload circuitry 139 for processing. If data for page z has been processed, process flow 600 moves to decision 640. If the data for page z is still being processed, process flow moves to decision 630.

Moving from decision 625 to decision 630, if data for additional pages of the x pages beyond the first page have been prefetched to Coh cache 132, the additional pages are shown as “page z+1”, then process flow 600 moves to block 635. In other words, the data for page z+1 would be a cache hit for Coh cache 132. If not prefetched to Coh cache 132 (cache miss), then process flow 600 moves to decision 640.

Moving from decision 630 to block 635, data from page z and from page z+1 is provided to offload circuitry 139 for processing.

Moving from decision 625 or decision 630 or block 635 to decision 640, additional pages of the x pages beyond z or z+1 pages is depicted as “page i”. In some examples, logic and/or features of prefetch circuitry 133 such as AT logic 137 determines whether a dTLB entry for page i has been prefetched from IOMMU 119 via AT prefetch path 144 to translate a GVA for page i to an HPA. If prefetched, process flow 600 moves to decision 645. If not prefetched, process flow moves to decision 655.

Moving from decision 640 to decision 645, AT logic 137 can determine whether dTLB entries for an address translation of page i and for any additional pages indicated as “page i+1” have been prefetched and added to dTLB 134. If prefetched and added to dTLB 134, process flow 600 moves to block 650. If not prefetched and added to dTLB 134, process flow moves to decision 655.

Moving from decision 645 to block 650, logic and/or features of prefetch circuitry 133 such as cache logic 135 can prefetch page i data and for data page i+1 from system memory 122 via Coh cache prefetch path 142 routed over communication link 140 using the page i and page i+1 dTLB entries that were prefetched and added to dTLB 134.

Moving from decision 640 or 645 or block 650 to decision 655, additional pages of the x pages beyond z, z+1, i, or i+1 pages is depicted as “page j”. In some examples, logic and/or features of prefetch circuitry 133 such as AT logic 137 determines whether dTLB entries for page j have been prefetched from IOMMU 119 via AT prefetch path 144 and added to dTLB 134. If prefetched and added to dTLB 134, process flow 600 moves to decision 660. If not prefetched and added to dTLB 134, process flow moves to decision 670.

Moving from decision 655 to decision 660, AT logic 137 can determine whether a page “page j+1” exists. For example, if page j was the last page of the x number of pages, then page j+1 does not exist and process flow 600 moves to decision 670. If page j+1 does exist, process flow 600 moves to block 665. Although process flow only shows a page j+1, examples are not limited to j+1, additional pages can exist based, at least in part, on a size or capacity of dTLB 134 to hold prefetched dTLB entries.

Moving from decision 660 to block 665, AT logic 137 can cause dTLB entries for an address translation of page j+1 to be prefetched from IOMMU 119 via AT prefetch path 144 and added to dTLB 134.

Moving from decision 655 or decision 660 or block 665 to decision 670, a determination is made to whether all data in the received request has been processed. If all data has been processed, process flow 600 moves to block 675. Otherwise, process flow 600 returns to decision 625.

Moving from decision 670 to block 675, post processing is completed and that can include finishing any actions needed after all the data has been processed.

Moving to 680, a response to the request received from the application is provided via a put response. Process flow 600 then comes to an end.

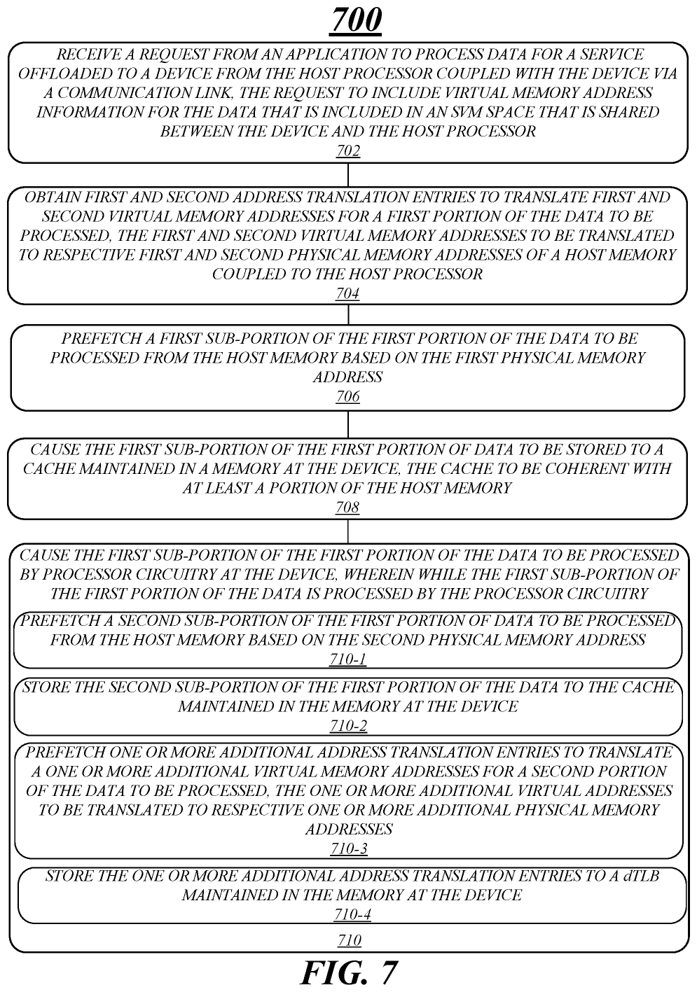

FIG. 7 illustrates an example logic flow 700. Logic flow 700 may be representative of some or all of the operations executed by one or more logic and/or features of circuitry at a device coupled with a host root complex for a host processor or CPU via a communication link such as circuitry 136 of device 130 that includes prefetch circuitry 133 and offload circuitry 139. Device 130, as shown in FIG. 1, can be coupled with host root complex 110 via communication link 140. As mentioned above, host root complex 110 can be included in a host processor or CPU and can also be coupled with a host memory 120 that includes a system memory 122 that can be arranged to have an SVM space. In some examples, logic flow 700 can be implemented by logic and/or features of prefetch circuitry 133 such as cache logic 135 or AT logic 137, although examples are not limited to implementation by these logic and/or features of a circuitry.

According to some examples, logic flow 700 at block 702 can receive a request from an application to process data for a service offloaded to a device from the host processor coupled with the device via a communication link, the request to include virtual memory address information for the data that is included in an SVM space that is shared between the device and the host processor. For these examples, logic and/or features of prefetch circuitry 133 such as AT logic 137 can receive the request from the application for offload circuitry 139 to process the data.

In some examples, logic flow 700 at block 704 can obtain first and second address translation entries to translate first and second virtual memory addresses for a first portion of the data to be processed, the first and second virtual memory addresses to be translated to respective first and second physical memory addresses of a host memory coupled to the host processor. For these examples, AT logic 137 can obtain the first and second address translation entries from IOMMU 119 at host root complex 110 in order to translate the first portion of data to be processed. For example the first and second address translation entries can be added or stored to dTLB 134 at device and then the entries can be used to translate the first and second virtual memory addresses to respective first and second physical memory addresses of host memory 120.

According to some examples, logic flow 700 at block 706 can prefetch a first sub-portion of the first portion of the data to be processed from the host memory based on the first physical memory address. For these examples, logic and/or features of prefetch circuitry 133 such as cache logic 135 can prefetch the first sub-portion of the first portion of the data from system memory 122 of host memory 120 based on the first physical memory address that was translated from the first virtual memory address using the obtained first address translation entry that was added or stored to dTLB 134. The first sub-portion can be a first memory page associated with a first virtual memory address included in the SVM space shared between device 130 and the host processor or CPU that includes host root complex 110.

In some examples, logic flow 700 at block 708 can cause the first sub-portion of the first portion of data to be stored to a cache maintained in a memory at the device, the cache to be coherent with at least a portion of the host memory. For these examples, cache logic 135 can cause the first sub-portion of the first portion of data to be stored to Coh cache 132. Coh cache 132 can maintain coherency with at least a portion of system memory 122 using CXL.cache protocols.

According to some examples, logic flow 700 at block 710 can cause the first sub-portion of the first portion of the data to be processed by processor circuitry at the device. For these examples, the first sub-portion of the first portion of the data can be processed by offload circuitry 139. Also, logic flow 700 at block 710, while the first sub-portion of the first portion of the data is processed by the processor circuitry, can implement sub-blocks 710-1 to 710-4.

In some examples, logic flow 700 at sub-block 710-1 can prefetch a second sub-portion of the first portion of data to be processed from the host memory based on the second physical memory address. For these examples, cache logic 135 can prefetch the second sub-portion from host memory 120.

According to some examples, logic flow 700 at sub-block 710-2 can store the second sub-portion of the first portion of the data to the cache maintained in the memory at the device. For these examples, cache logic 135 can store the second sub-portion to Coh cache 132.

In some examples, logic flow 700 at sub-block 710-3 can prefetch one or more additional address translation entries to translate a one or more additional virtual memory addresses for a second portion of the data to be processed, the one or more additional virtual memory addresses to be translated to one or more additional physical memory addresses. For these examples, AT logic 137 can prefetch the one or more additional translation entries from IOMMU 119 at host root complex 110.

According to some examples, logic flow 700 at sub-block 710-4 can store the respective one or more additional address translation entries to a dTLB maintained in the memory at the device. For these examples, AT logic 137 can store the one or more additional address translation entries to dTLB 134. Also, the prefetching and storing of the one or more additional address translation entries while the first sub-portion of the data is being processed provides additional time to deal with potential page faults, as described above for address translation scheme 200, before needing to prefetch the first sub-portion of the data from host memory 120 based on translation of the one or more additional virtual memory addresses.

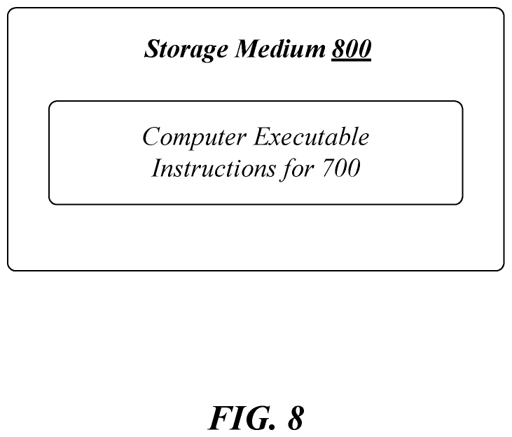

FIG. 8 illustrates an example of a storage medium. As shown in FIG. 8, the storage medium includes a storage medium 800. The storage medium 800 may comprise an article of manufacture. In some examples, storage medium 800 may include any non-transitory computer readable medium or machine readable medium, such as an optical, magnetic or semiconductor storage. Storage medium 800 may store various types of computer executable instructions, such as instructions to implement logic flow 700. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

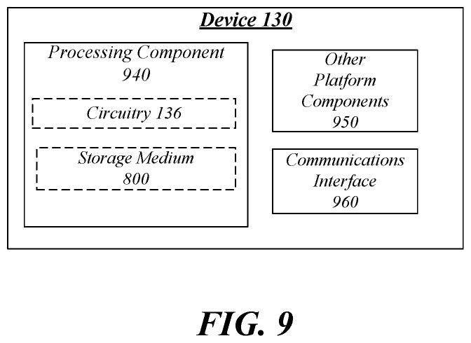

FIG. 9 illustrates an example of a device. In some examples, as shown in FIG. 9, the example device can be device 130 that was shown in FIG. 1 and described in various aspects above. For these examples, device 130 can include a processing component 940, other platform components 950 or a communications interface 960. According to some examples, device 130 can be capable of coupling to a computing platform or to a network of computing platforms.

According to some examples, processing component 940 can include circuitry 136 and a storage medium such as storage medium 800. Processing component 940 can include various hardware elements, software elements, or a combination of both. Examples of hardware elements can be circuitry 136 that includes prefetch circuitry 133 and offload circuitry 139. Examples of software elements can include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 950 can include, memory units (e.g., memory 131), chipsets, controllers, interfaces, oscillators, timing devices, power supplies, and so forth. Examples of memory units can include without limitation various types of computer readable and machine readable storage media in the form of one or more higher speed memory units, such as read-only memory (ROM), RAM, DRAM, Double-Data-Rate DRAM (DDRAM), SDRAM, SRAM, programmable ROM (PROM), erasable programmable ROM (EPROM), electrically erasable programmable ROM (EEPROM), types of non-volatile memory. Other types of computer readable and machine readable storage media can also include magnetic or optical cards, an array of devices such as Redundant Array of Independent Disks (RAID) drives, solid state memory devices (e.g., USB memory), solid state drives (SSD) and any other type of storage media suitable for storing information.

In some examples, communications interface 960 can include logic and/or features to support a communication interface. For these examples, communications interface 960 can include one or more communication interfaces that operate according to various communication protocols or standards to communicate over direct or network communication links or channels. Direct communications can occur via use of communication protocols or standards described in one or more industry standards (including progenies and variants) such as those associated with the PCIe specification or the CXL specification. Network communications can occur via use of communication protocols or standards such those described in one or more Ethernet standards promulgated by IEEE. For example, one such Ethernet standard can include IEEE 802.3. Network communication can also occur according to one or more OpenFlow specifications such as the OpenFlow Hardware Abstraction API Specification.

The components and features of device 130 can be implemented using any combination of discrete circuitry, ASICs, logic gates and/or single chip architectures. Further, the features of device 130 can be implemented using microcontrollers, programmable logic arrays and/or microprocessors or any combination of the foregoing where suitably appropriate. It is noted that hardware, firmware and/or software elements can be collectively or individually referred to herein as “circuitry”, “logic” or “feature.”

It should be appreciated that the example device 130 shown in the block diagram of FIG. 9 can represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Although not depicted, any system or device can include and use a power supply such as but not limited to a battery, AC-DC converter at least to receive alternating current and supply direct current, renewable energy source (e.g., solar power or motion based power), or the like.

One or more aspects of at least one example may be implemented by representative instructions stored on at least one machine-readable medium which represents various logic within a processor, processor circuit, ASIC, or FPGA which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the processor, processor circuit, ASIC, or FPGA.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The following examples pertain to additional examples of technologies disclosed herein.

Example 1. An example device can include a memory, first circuitry configured to process data for a service offloaded from a host processor coupled with the device via a communication link, and second circuitry. The second circuitry can be configured to receive a request from an application to process data for the service. The request can include virtual memory address information for the data that is included in an SVM space that is shared between the device and the host processor. The second circuitry can also be configured to obtain first and second address translation entries to translate first and second virtual memory addresses for a first portion of the data to be processed. The first and second virtual memory addresses can be translated to respective first and second physical memory addresses of a host memory coupled to the host processor. The second circuitry can also be configured to prefetch a first sub-portion of the first portion of the data to be processed from the host memory based on the first physical memory address. The second circuitry can also be configured to store the first sub-portion of the first portion of data to a cache maintained in the memory. The cache can be coherent with at least a portion of the host memory. The second circuitry can also be configured to cause the first sub-portion of the first portion of the data to be processed by the first circuitry. For this example, while the first sub-portion of the first portion of the data is processed by the first circuitry, the second circuitry is to prefetch a second sub-portion of the first portion of data to be processed from the host memory based on the second physical memory address. The second circuitry is also to store the second sub-portion of the first portion of the data to the cache maintained in the memory. The second circuitry is also to prefetch one or more additional address translation entries to translate one or more additional virtual memory addresses for a second portion of the data to be processed, the one or more additional virtual memory addresses to be translated to respective one or more additional physical memory addresses. The second circuitry is also to store the one or more additional address translation entries to a dTLB maintained in the memory.

Example 2. The device of example 1, subsequent to the first sub-portion of the first portion of data being processed by the first circuitry, the second circuitry can further cause the second sub-portion of the first portion of the data to be processed by the first circuitry. For this example, while the second sub-portion of the first portion of the data is processed by the first circuitry, the second circuitry is to prefetch the second portion of data to be processed from the host memory based on the respective one or more additional physical memory addresses. The second circuitry is to also store the second portion of the data to the cache maintained in the memory. The second circuitry is to also prefetch one or more additional address translation entries to translate one or more additional virtual memory addresses for a third portion of the data to be processed. The second circuitry is to also store the one or more additional address translation entries to translate the one or more additional virtual memory addresses for a third portion of the data to the dTLB maintained in the memory.

Example 3. The device of example 1, the first and second virtual memory addresses for the first portion of data can correspond to first and second memory pages included in the SVM space. For this example, the one or more additional virtual memory addresses for the second portion of data can correspond to one or more additional memory pages included in the SVM space. Example 4. The device of example 1, the host processor coupled with the device via the communication link can include the communication link configured to operate according to a specification to include the CXL specification. Example 5. The device of example 4, the first and second address translations can be obtained and the one or more additional address translation entries can prefetched over the communication link from an IOMMU at a host root complex of the host processor. The host root complex can be configured to operate according to the CXL specification.

Example 6. The device of example 5, the first and second sub-portions of the first portion of data can be prefetched from the host memory over the communication link and through the host root complex. Example 7. The device of example 6, the cache to be coherent with at least a portion of the host memory can include the second circuitry to be configured to use CXL.cache protocols to maintain coherency between the cache and the at least a portion of the host memory.

Example 8. An example method can include receiving a request from an application to process data for a service offloaded to a device from a host processor coupled with the device via a communication link. The request can include virtual memory address information for the data that is included in an SVM space that is shared between the device and the host processor. The method can also include obtaining first and second address translation entries to translate first and second virtual memory addresses for a first portion of the data to be processed. The first and second virtual memory addresses can be translated to respective first and second physical memory addresses of a host memory coupled to the host processor. The method can also include prefetching a first sub-portion of the first portion of the data to be processed from the host memory based on the first physical memory address. The method can also include causing the first sub-portion of the first portion of data to be stored to a cache maintained in a memory at the device. The cache can be coherent with at least a portion of the host memory. The method can also include causing the first sub-portion of the first portion of the data to be processed by processor circuitry at the device. For this example, while the first sub-portion of the first portion of the data is processed by the processor circuitry, the method can also include prefetching a second sub-portion of the first portion of data to be processed from the host memory based on the second physical memory address. The method can also include storing the second sub-portion of the first portion of the data to the cache maintained in the memory at the device. The method can also include prefetching one or more additional address translation entries to translate one or more additional virtual memory addresses for a second portion of the data to be processed. The one or more additional virtual memory addresses can be translated to respective one or more additional physical memory addresses. The method can also include storing the one or more additional address translation entries to a dTLB maintained in the memory at the device.

Example 9. The method of example 8, subsequent to the first sub-portion of the first portion of data being processed by the processor circuitry at the device, the method can further include causing the second sub-portion of the first portion of the data to be processed by the processor circuitry. For this example, while the second sub-portion of the first portion of the data is processed by the processor circuitry, the method can also include prefetching the second portion of data to be processed from the host memory based on the respective one or more additional physical memory addresses. The method can also include storing the second portion of the data to the cache maintained in the memory. The method can also include prefetching one or more additional address translation entries to translate one or more additional virtual memory addresses for a third portion of the data to be processed. The method can also include the one or more additional virtual memory addresses to be translated to second respective one or more additional physical memory addresses. The method can also include storing the one or more additional address translation entries to translate the one or more additional virtual memory addresses for a third portion of the data to the dTLB maintained in the memory.

Example 10. The method example 8, the first and second virtual memory addresses for the first portion of data can correspond to first and second memory pages included in the SVM space. For these examples, the one or more additional virtual memory addresses for the second portion of data can correspond to one or more additional memory pages included in the SVM space.

Example 11. The method of example 8, the host processor coupled with the device via the communication link can include the communication link configured to operate according to a specification to include the CXL specification.

Example 12. The method of example 11, the first and second address translations can be obtained and the one or more additional address translation entries can be prefetched over the communication link from an IOMMU at a host root complex of the host processor. The host root complex can be configured to operate according to the CXL specification.

Example 13. The method of example 12, the first and second sub-portions of the first portion of data can be prefetched from the host memory over the communication link and through the host root complex.

Example 14. The method of example 13, the cache to be coherent with at least a portion of the host memory can include using CXL.cache protocols to maintain coherency between the cache and the at least a portion of the host memory.

Example 15. An example at least one machine readable medium can include a plurality of instructions that in response to being executed by a system can cause the system to carry out a method according to any one of examples 8 to 14.

Example 16. An example apparatus can include means for performing the methods of any one of examples 8 to 14.

Example 17. An example at least one non-transitory computer-readable storage medium, including a plurality of instructions, that when executed, can cause circuitry at a device coupled with a host processor via a communication link to receive a request from an application to process data for a service offloaded to the device from the host processor. The request can include virtual memory address information for the data that is included in an SVM space that is shared between the device and the host processor. The instructions can also cause the circuitry to obtain first and second address translation entries to translate first and second virtual memory addresses for a first portion of the data to be processed. The first and second virtual memory addresses can be translated to respective first and second physical memory addresses of a host memory coupled to the host processor. The instructions can also cause the circuitry to prefetch a first sub-portion of the first portion of the data to be processed from the host memory based on the first physical memory address. The instructions can also cause the circuitry to cause the first sub-portion of the first portion of data to be stored to a cache maintained in a memory at the device. The cache can be coherent with at least a portion of the host memory. The instructions can also cause the circuitry to cause the first sub-portion of the first portion of the data to be processed by processor circuitry at the device. For this example, while the first sub-portion of the first portion of the data is processed by the processor circuitry, the instructions are to further cause the circuitry to prefetch a second sub-portion of the first portion of data to be processed from the host memory based on the second physical memory address. The instructions can also further cause the circuitry to store the second sub-portion of the first portion of the data to the cache maintained in the memory at the device. The instructions can also further cause the circuitry to prefetch one or more additional address translation entries to translate one or more additional virtual memory addresses for a second portion of the data to be processed, the one or more additional virtual memory addresses to be translated to respective one or more additional physical memory addresses. The instructions can also further cause the circuitry to store the one or more additional address translation entries to a dTLB maintained in the memory at the device.

Example 18. The least one non-transitory computer-readable storage medium of example 17, subsequent to the first sub-portion of the first portion of data being processed by the processor circuitry at the device, the instructions are to further cause the circuitry to cause the second sub-portion of the first portion of the data to be processed by the processor circuitry. For this example, while the second sub-portion of the first portion of the data is processed by the processor circuitry, the instructions are to further cause the circuitry to prefetch the second portion of data to be processed from the host memory based on the respective one or more additional physical memory addresses. The instructions can also further cause the circuitry to store the second portion of the data to the cache maintained in the memory. The instructions can also further cause the circuitry to prefetch one or more additional address translation entries to translate one or more additional virtual memory addresses for a third portion of the data to be processed. The one or more additional virtual memory addresses to be translated to second respective one or more additional physical memory addresses. The instructions can also further cause the circuitry to store the one or more additional address translation entries to translate the one or more additional virtual memory addresses for a third portion of the data to the dTLB maintained in the memory.

Example 19. The least one non-transitory computer-readable storage medium of example 17, the first and second virtual memory addresses for the first portion of data can correspond to first and second memory pages included in the SVM space. For this example, the one or more additional virtual memory addresses for the second portion of data can correspond to one or more additional memory pages included in the SVM space.

Example 20. The least one non-transitory computer-readable storage medium of example 17, the host processor coupled with the device via the communication link can include the communication link being configured to operate according to a specification to include the Compute Express Link (CXL) specification.

Example 21. The least one non-transitory computer-readable storage medium of example 20, the first and second address translations can be obtained and the one or more additional address translation entries can be prefetched over the communication link from an IOMMU at a host root complex of the host processor. The host root complex can be configured to operate according to the CXL specification.

Example 22. The least one non-transitory computer-readable storage medium of example 19, the first and second sub-portions of the first portion of data can be prefetched from the host memory over the communication link and through the host root complex.

Example 23. The least one non-transitory computer-readable storage medium of example 22, the cache to be coherent with at least a portion of the host memory can include the instructions to further cause the circuitry to use CXL.cache protocols to maintain coherency between the cache and the at least a portion of the host memory.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A device comprising:
a memory;
first circuitry configured to process data for a service offloaded from a host processor coupled with the device via a communication link; and
second circuitry configured to:
receive a request from an application to process data for the service, the request to include virtual memory address information for the data that is included in a shared virtual memory (SVM) space that is shared between the device and the host processor;
obtain first and second address translation entries to translate first and second virtual memory addresses for a first portion of the data to be processed, the first and second virtual memory addresses to be translated to respective first and second physical memory addresses of a host memory coupled to the host processor;
prefetch a first sub-portion of the first portion of the data to be processed from the host memory based on the first physical memory address;
store the first sub-portion of the first portion of data to a cache maintained in the memory, the cache to be coherent with at least a portion of the host memory; and
cause the first sub-portion of the first portion of the data to be processed by the first circuitry, wherein while the first sub-portion of the first portion of the data is processed by the first circuitry, the second circuitry is to:
prefetch a second sub-portion of the first portion of data to be processed from the host memory based on the second physical memory address;
store the second sub-portion of the first portion of the data to the cache maintained in the memory;
prefetch one or more additional address translation entries to translate one or more additional virtual memory addresses for a second portion of the data to be processed, the one or more additional virtual memory addresses to be translated to respective one or more additional physical memory addresses; and
store the one or more additional address translation entries to a device address translation table (dTLB) maintained in the memory.

2. The device of claim 1, wherein subsequent to the first sub-portion of the first portion of data being processed by the first circuitry, the second circuitry is further to:
cause the second sub-portion of the first portion of the data to be processed by the first circuitry, wherein while the second sub-portion of the first portion of the data is processed by the first circuitry, the second circuitry is to:
prefetch the second portion of data to be processed from the host memory based on the respective one or more additional physical memory addresses;
store the second portion of the data to the cache maintained in the memory;
prefetch one or more additional address translation entries to translate one or more additional virtual memory addresses for a third portion of the data to be processed; and
store the one or more additional address translation entries to translate the one or more additional virtual memory addresses for a third portion of the data to the dTLB maintained in the memory.

3. The device of claim 1, wherein the first and second virtual memory addresses for the first portion of data correspond to first and second memory pages included in the SVM space, and wherein the one or more additional virtual memory addresses for the second portion of data correspond to one or more additional memory pages included in the SVM space.

4. The device of claim 1, the host processor coupled with the device via the communication link comprises the communication link configured to operate according to a specification to include the Compute Express Link (CXL) specification.

5. The device of claim 4, wherein the first and second address translations are obtained and the one or more additional address translation entries are prefetched over the communication link from an input/out memory management unit (IOMMU) at a host root complex of the host processor, the host root complex configured to operate according to the CXL specification.

6. The device of claim 5, wherein the first and second sub-portions of the first portion of data are prefetched from the host memory over the communication link and through the host root complex.

7. The device of claim 6, the cache to be coherent with at least a portion of the host memory comprises the second circuitry to be configured to use CXL.cache protocols to maintain coherency between the cache and the at least a portion of the host memory.

8. A method comprising:
receiving a request from an application to process data for a service offloaded to a device from a host processor coupled with the device via a communication link, the request to include virtual memory address information for the data that is included in a shared virtual memory (SVM) space that is shared between the device and the host processor;
obtaining first and second address translation entries to translate first and second virtual memory addresses for a first portion of the data to be processed, the first and second virtual memory addresses to be translated to respective first and second physical memory addresses of a host memory coupled to the host processor;
prefetching a first sub-portion of the first portion of the data to be processed from the host memory based on the first physical memory address;
causing the first sub-portion of the first portion of data to be stored to a cache maintained in a memory at the device, the cache to be coherent with at least a portion of the host memory; and
causing the first sub-portion of the first portion of the data to be processed by processor circuitry at the device, wherein while the first sub-portion of the first portion of the data is processed by the processor circuitry,
prefetching a second sub-portion of the first portion of data to be processed from the host memory based on the second physical memory address,
storing the second sub-portion of the first portion of the data to the cache maintained in the memory at the device,
prefetching one or more additional address translation entries to translate one or more additional virtual memory addresses for a second portion of the data to be processed, the one or more additional virtual memory addresses to be translated to respective one or more additional physical memory addresses, and
storing the one or more additional address translation entries to a device address translation table (dTLB) maintained in the memory at the device.

9. The method of claim 8, wherein subsequent to the first sub-portion of the first portion of data being processed by the processor circuitry at the device, the method further comprising:
causing the second sub-portion of the first portion of the data to be processed by the processor circuitry, wherein while the second sub-portion of the first portion of the data is processed by the processor circuitry,
prefetching the second portion of data to be processed from the host memory based on the respective one or more additional physical memory addresses,
storing the second portion of the data to the cache maintained in the memory,
prefetching one or more additional address translation entries to translate one or more additional virtual memory addresses for a third portion of the data to be processed, the one or more additional virtual memory addresses to be translated to second respective one or more additional physical memory addresses, and
storing the one or more additional address translation entries to translate the one or more additional virtual memory addresses for a third portion of the data to the dTLB maintained in the memory.

10. The method claim 8, wherein the first and second virtual memory addresses for the first portion of data correspond to first and second memory pages included in the SVM space, and wherein the one or more additional virtual memory addresses for the second portion of data correspond to one or more additional memory pages included in the SVM space.

11. The method of claim 8, the host processor coupled with the device via the communication link comprises the communication link configured to operate according to a specification to include the Compute Express Link (CXL) specification.

12. The method of claim 11, wherein the first and second address translations are obtained and the one or more additional address translation entries are prefetched over the communication link from an input/out memory management unit (IOMMU) at a host root complex of the host processor, the host root complex configured to operate according to the CXL specification.

13. The method of claim 12, wherein the first and second sub-portions of the first portion of data are prefetched from the host memory over the communication link and through the host root complex.

14. The method of claim 13, the cache to be coherent with at least a portion of the host memory comprises using CXL.cache protocols to maintain coherency between the cache and the at least a portion of the host memory.

15. At least one non-transitory computer-readable storage medium, comprising a plurality of instructions, that when executed, cause circuitry at a device coupled with a host processor via a communication link to:
receive a request from an application to process data for a service offloaded to the device from the host processor, the request to include virtual memory address information for the data that is included in a shared virtual memory (SVM) space that is shared between the device and the host processor;
obtain first and second address translation entries to translate first and second virtual memory addresses for a first portion of the data to be processed, the first and second virtual memory addresses to be translated to respective first and second physical memory addresses of a host memory coupled to the host processor;
prefetch a first sub-portion of the first portion of the data to be processed from the host memory based on the first physical memory address;
cause the first sub-portion of the first portion of data to be stored to a cache maintained in a memory at the device, the cache to be coherent with at least a portion of the host memory; and
cause the first sub-portion of the first portion of the data to be processed by processor circuitry at the device, wherein while the first sub-portion of the first portion of the data is processed by the processor circuitry, the instructions are to further cause the circuitry to:
prefetch a second sub-portion of the first portion of data to be processed from the host memory based on the second physical memory address;
store the second sub-portion of the first portion of the data to the cache maintained in the memory at the device;
prefetch one or more additional address translation entries to translate one or more additional virtual memory addresses for a second portion of the data to be processed, the one or more additional virtual memory addresses to be translated to respective one or more additional physical memory addresses; and
store the one or more additional address translation entries to a device address translation table (dTLB) maintained in the memory at the device.

16. The least one non-transitory computer-readable storage medium of claim 15, wherein subsequent to the first sub-portion of the first portion of data being processed by the processor circuitry at the device, the instructions are to further cause the circuitry to:
cause the second sub-portion of the first portion of the data to be processed by the processor circuitry, wherein while the second sub-portion of the first portion of the data is processed by the processor circuitry, the instructions are to further cause the circuitry to:
prefetch the second portion of data to be processed from the host memory based on the respective one or more additional physical memory addresses;
store the second portion of the data to the cache maintained in the memory;
prefetch one or more additional address translation entries to translate one or more additional virtual memory addresses for a third portion of the data to be processed, the one or more additional virtual memory addresses to be translated to second respective one or more additional physical memory addresses; and
store the one or more additional address translation entries to translate the one or more additional virtual memory addresses for a third portion of the data to the dTLB maintained in the memory.

17. The least one non-transitory computer-readable storage medium of claim 15, wherein the first and second virtual memory addresses for the first portion of data correspond to first and second memory pages included in the SVM space, and wherein the one or more additional virtual memory addresses for the second portion of data correspond to one or more additional memory pages included in the SVM space.

18. The least one non-transitory computer-readable storage medium of claim 15, the host processor coupled with the device via the communication link comprises the communication link configured to operate according to a specification to include the Compute Express Link (CXL) specification.

19. The least one non-transitory computer-readable storage medium of claim 18, wherein the first and second address translations are obtained and the one or more additional address translation entries are prefetched over the communication link from an input/out memory management unit (IOMMU) at a host root complex of the host processor, the host root complex configured to operate according to the CXL specification.

20. The least one non-transitory computer-readable storage medium of claim 19, wherein the first and second sub-portions of the first portion of data are prefetched from the host memory over the communication link and through the host root complex, and wherein the cache to be coherent with at least a portion of the host memory comprises the instructions to further cause the circuitry to use CXL.cache protocols to maintain coherency between the cache and the at least a portion of the host memory.
